(19) United States
(12) Patent Application Publication
(10) Pub. No.: US 2012/0099419 A1
(43) Pub. Date: Apr. 26, 2012

(54) METHOD FOR TRANSMITTING RETRANSMISSION REQUEST INFORMATION FOR AN ERROR PACKET IN A MULTIMEDIA BROADCAST/MULTICAST SERVICE, AND METHOD FOR RETRANSMITTING A PACKET IN RESPONSE TO THE RETRANSMISSION REQUEST

(75) Inventors: Jae Heung Kim, Daejeon (KR); Tae Gyun Noh, Daejeon (KR)

(73) Assignee: ELECTRONICS AND TELECOMMUNICATIONS RESEARCH INSTITUTE, Daejeon (KR)

(21) Appl. No.: 13/380,250

(22) PCT Filed: Jun. 23, 2010
(86) PCT No.: PCT/KR10/04061

§ 371 Date: Dec. 22, 2011

(30) Foreign Application Priority Data
Jun. 23, 2009 (KR) 10-2009-0055863

(51) Int. Cl. H04W 24/04

(52) U.S. Cl. 370/216

(57) ABSTRACT

Disclosed is a method in which a terminal transmits retransmission request information for an error packet of a multimedia broadcast/multicast service (MBMS), and a base station retransmits a packet in the multimedia broadcast/multicast service. The method in which the terminal transmits retransmission request information for an error packet comprises: a step of receiving an MBMS packet from the base station; a step of checking whether or not an error exists in the received MBMS packet; and a step of transmitting retransmission request information for the error packet using at least one of PUSCH, PUCCH and a random access preamble for a random access process if an error exists in the received MBMS packet. The present invention achieves improved service satisfaction among terminals located on an intercell boundary, an MBSFN boundary, and regions with a poor wireless environment.

### TECHNICAL FIELD

The present invention relates to a multimedia broadcast/multicast service (MBMS), and more particularly, to a method of transmitting a retransmission request for a packet in which an error has occurred while an MBMS is received and a method of retransmitting the error packet in response to the retransmission request to improve reliability of the service.

### BACKGROUND ART

Third generation partnership project (3GPP)-based conventional cellular systems employ code division multiple access (CDMA), and provide an MBMS using a secondary common control physical channel (S-CCPCH) reserving and allocating some codes for the MBMS.

3GPP wideband CDMA (WCDMA) systems based on an asynchronous inter-base-station operation support an MBMS single frequency network (MBSFN) function to adjust synchronization of a downlink physical channel (DPCH), thereby improving the quality of a wireless link channel using soft and selective combining functions between multiple paths in a terminal.

Long term evolution (LTE) systems are packet-based systems intended to provide a pure packet service, and will provide various packet services such as Internet protocol (IP)-based voice service, gaming, file transfer protocol (FTP), video streaming, and multicast or broadcast service.

To this end, a service network simply consists of a terminal, a base station (or cell), an access gateway (aGW), which is an end point of the network, etc., and the base station and the terminal are controlled according to two states only, that is, RRC_IDLE and RRC_CONNECTED. Also, LTE systems adopt orthogonal frequency division multiplexing (OFDM) or orthogonal frequency division multiple access (OFDMA) as a multiple access scheme, and thus radio resource allocation is performed not by code allocation but by two-dimensional allocation of frequency and time.

FIG. 1 is a conceptual diagram illustrating an MBMS constitution of a 3GPP LTE system.

Referring to FIG. 1, a base station or cell 101 accesses an evolved packet core

(EPC) network 102, which is a network of a packet-based cellular system, through an aGW 103, which is an edge node of the EPC network 102, and terminals 105 can access the cellular network through the base station or cell 101.

A base station can be accessed for an MBMS using an MBMS GW 107, which is another gateway. An MBMS control function 104 which manages and controls data for supporting an MBMS may be prepared in an aGW or base station, or present as a separate function connected with an aGW and base station through an interface (see 106 of FIG. 1).

Also, MBMS control functions may be distributed to an aGW and a base station. The MBMS control function serves to support MBMS data traffic and service, and allocates and schedules radio resources for base stations or cells participating in an MBSFN operation. Thus, base stations determine a modulation and coding scheme (MCS) level for MBSFN transmission according to a control of the MBMS control function.

A cellular system for supporting an MBMS can perform MBMS transmission using a variety of base stations in a hierarchical base station environment. In a cellular system supporting an MBMS, base stations can be classified into base stations or cells dedicated to an MBMS, mixed-service base stations or cells (e.g., mixed cells) supporting an MBMS and a unicast service together, general base stations or cells not supporting an MBMS, and so on.

OFDM(A)-based cellular systems may employ an MBSFN operation for an MBMS to improve performance of terminals in the boundary area of a base station or cell. The MBSFN operation is a scheme for a plurality of base stations to overcome performance deterioration caused by a wireless environment such as interference and efficiently provide an MBMS to terminals at a cell boundary.

FIG. 2 is a diagram illustrating the concept of an MBMS of a 3GPP LTE system. As shown in FIG. 2, for such an MBSFN operation, base stations or cells 201 or 202 in the same MBSFN area should transmit the same MBMS information at the same MCS level in a determined scheduling period or at a determined transmission timing using a designated transmission frequency band (or carrier). Thus, in the MBSFN area, terminals 203 receive packet information for an MBMS from a plurality of cells to obtain diversity gain, and thus can receive service satisfying quality that a system wants to provide even in a poor wireless channel environment.

In an MBMS, a plurality of base stations generally participate in an MBSFN operation as mentioned above. However, one single-cell MBSFN transmission base station 204 alone can provide the MBMS in an MBSFN mode, or single-cell transmission in which the MBMS is provided by only one base station or cell 205 is enabled in a mode other than the MBSFN mode. In this case, the MBMS is received from the corresponding base station within the corresponding base station area only. Thus, receiving performance at the cell boundary deteriorates, and a solution is required.

Also, a solution for improving performance of terminals provided with an MBMS at the boundary of an MBSFN area, at a cell boundary, in a poor wireless environment, or in a single-cell area, is required even in an MBSFN mode operation.

Such performance deterioration can be overcome by repeated transmission or an MCS. It is assumed that the base stations 201 to 205 capable of providing an MBMS provide an MBMS and a unicast service at the same time. Radio resources for transmitting a unicast service are allocated separately from radio resources for an MBMS on a time plane or frequency plane, so that an MBMS can be provided with all services that general base stations 206 provide.

However, a conventional MBMS does not support retransmission for correcting an error occurring during transmission of an MBMS packet. Consequently, LTE systems require a BMS capable of retransmitting an error packet to terminals located in an inter-cell boundary area or at the boundary of an MBSFN area and in a poor wireless environment area to provide service satisfying reference performance required by the systems or more even in an MBSFN mode operation of an MBMS.

### DISCLOSURE

### Technical Problem

The present invention is directed to providing a method of transmitting retransmission request information requesting a base station to retransmit a multimedia broadcast/multicast service (MBMS) packet when a terminal receiving an MBMS detects an error in the received MBMS packet, and improving service satisfaction of terminals located in an inter-cell boundary area or at the boundary of an MBMS single frequency network (MBSFN) area, and in a poor wireless environment area.

The present invention is also directed to providing a method for a base station providing an MBMS to receive retransmission request information requesting the base station to retransmit an MBMS packet from MBMS service target terminals and retransmit the requested MBMS packet, and improving service satisfaction of terminals located in an inter-cell boundary area or at the boundary of an MBSFN area, and in a poor wireless environment area.

### Technical Solution

One aspect of the present invention provides a method for a terminal to transmit retransmission request information for an error packet of a multimedia broadcast/multicast service (MBMS), the method including: receiving an MBMS packet from a base station; checking whether an error is in the received MBMS packet; and when an error is in the received MBMS packet, transmitting retransmission request information for the error packet using at least one of a physical uplink shared channel (PUSCH), a physical uplink control channel (PUCCH), and a random access (RA) preamble for a random access procedure.

Here, when the retransmission request information is transmitted using the PUSCH, the retransmission request information may be transmitted with information indicating an MBMS subframe in which the error packet has been transmitted included in the retransmission request information.

Here, when the retransmission request information is transmitted using the PUCCH, a relation between a downlink (DL) MBMS subframe and radio resources in the PUCCH of an uplink (UL) subframe may be set to indicate an MBMS subframe in which the error packet has been transmitted.

Here, when the retransmission request information is transmitted using the PUCCH, a relation between a UL grant information field of a DL control channel present in a DL MBMS subframe and radio resources in the PUCCH of a UL subframe may be set to indicate an MBMS subframe in which the error packet has been transmitted.

Here, when the retransmission request information is transmitted using the PUCCH, an MBMS subframe in which the error packet has been transmitted may be indicated using unused radio resources in the PUCCH of a UL subframe having a mapping relation with a physical downlink control channel (PDCCH) of a DL MBMS subframe.

Here, when the retransmission request information is transmitted using the RA preamble, the retransmission request information may be transmitted using an RA preamble reserved and allocated in advance for retransmission request information transmission between the terminal and the base station among RA preamble resources.

Here, at least one of scrambling and masking for specifying the base station to perform retransmission of the error packet is performed to transmit the retransmission request information.

Another aspect of the present invention provides a method for a base station to retransmit an error packet in response to retransmission request information for the error packet of an MBMS transmitted by a terminal, the method including: receiving error packet retransmission request information from at least one terminal present in a service area; and finding a packet in which an error has occurred on the basis of the retransmission request information, and retransmitting a retransmission packet for the packet in which an error has occurred in a subframe for unicast using a scheduling identifier reserved in advance for MBMS packet retransmission between the base station and terminals.

Here, retransmitting the retransmission packet may include transmitting the packet in which an error has occurred corresponding to the retransmission packet through a PDCCH transmitted using the scheduling identifier reserved in advance with information specifying an MBMS subframe of the packet in which an error has occurred included in the packet.

Here, the scheduling identifier may be reserved in advance to be plural in number for MBMS packet retransmission between the base station and the terminals, and the packet in which an error has occurred corresponding to the retransmission packet may be transmitted to specify an MBMS subframe of the packet in which an error has occurred using mapping relations between the scheduling identifiers and MBMS subframes.

Here, retransmitting the retransmission packet may include transmitting the packet in which an error has occurred corresponding to the retransmission packet to specify an MBMS subframe of the packet in which an error has occurred by setting in advance a timing relation between a DL MBMS subframe in which the packet in which an error has occurred is transmitted and a unicast subframe in which the retransmission packet is transmitted or a timing relation between a UL MBMS subframe in which the retransmission request information from the terminal is received and the unicast subframe in which the retransmission packet is transmitted.

### Advantageous Effects

Using the above-described method for a terminal to transmit error packet retransmission request information and the above-described method for a base station to retransmit an error packet according to an exemplary embodiment of the present invention, it is possible to improve the multimedia broadcast/multicast service (MBMS) satisfaction of terminals located in an inter-cell boundary area or at the boundary of an MBMS single frequency network (MBSFN) area and in a poor wireless environment area.

### DESCRIPTION OF DRAWINGS

FIG. 1 is a conceptual diagram illustrating a multimedia broadcast/multicast service (MBMS) constitution of a third generation partnership project (3GPP) long term evolution (LTE) system.

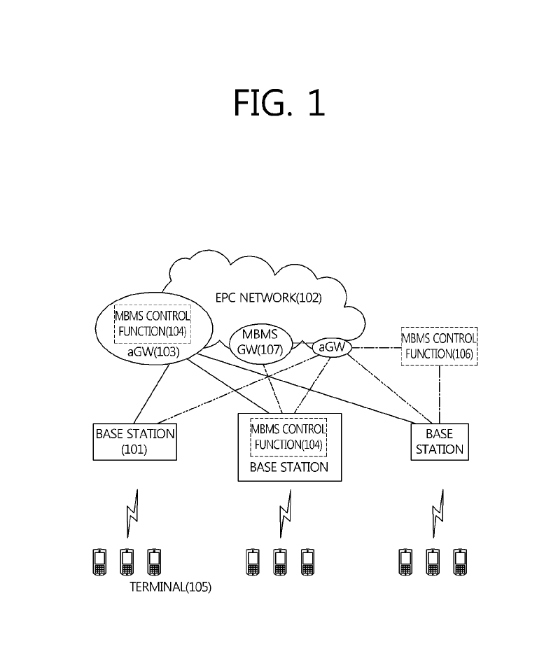

FIG. 2 is a diagram illustrating the concept of an MBMS of a 3GPP LTE system.

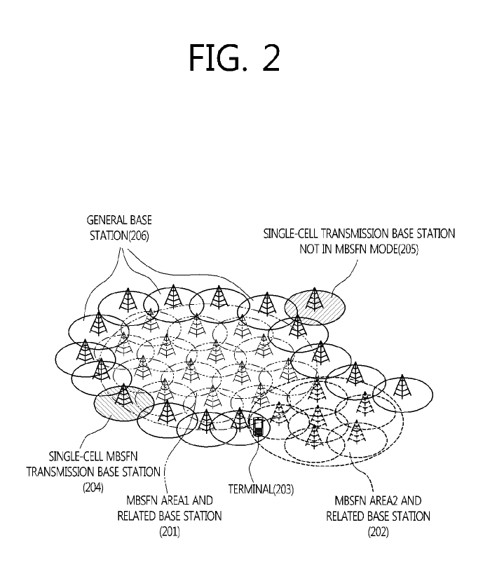

FIG. 3 is a frame timing diagram illustrating transmission and reception timing for an MBMS error packet retransmission request and MBMS packet retransmission corresponding to the retransmission request between a base station and a terminal.

FIG. 4 is a flowchart illustrating a method of transmitting error packet retransmission request information according to an exemplary embodiment of the present invention.

FIG. 5 is a flowchart illustrating a method of retransmitting an error packet in response to a retransmission request according to an exemplary embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

As used herein, the term “terminal” may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various exemplary embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

In this specification, the term “base station” used here generally denotes a fixed point communicating with a terminal, and may be referred to as a Node-B, evolved Node-B (eNode-B), base transceiver system (BTS), access point, and other terms.

With reference to the appended drawings, exemplary embodiments of the present invention will be described in detail below. To aid in understanding the present invention, like numbers refer to like elements throughout the description of the figures, and the description of the same component will not be reiterated.

To improve performance of terminals provided with a multimedia broadcast/multicast service (MBMS) at the boundary of an MBMS single frequency network (MBSFN) area, at a cell boundary, in a poor wireless environment area, or a single-cell area even in an MBSFN mode operation, a retransmission technique can be employed. In brief, a retransmission process for an MBMS can be performed through the following steps:
First step: a terminal receives MBMS control channel (MCCH) information together with resource allocation information including an MBMS subframe allocation pattern transmitted by a base station providing an MBMS.
Second step: the terminal receives a desired MBMS data packet among MBMS packets transmitted by the base station using control information.
Third step: the terminal which does not normally receive the MBMS packet reports failure of packet reception on an uplink (UL).
Fourth step: the base station checking the MBMS packet reception failure report transmitted by the terminal retransmits the MBMS packet.

To retransmit an MBMS data packet, feedback information which is used by terminals to inform a base station that the MBMS packet is not normally received is required. In other words, to efficiently perform a retransmission process, radio resource allocation and setting of related control parameters should be optimized for the fourth step in which a base station retransmits an MBMS packet as well as the third step in which a terminal reports failure of MBMS packet reception.

The third step in which a terminal receiving an MBMS transmits a feedback which requests a base station to retransmit a packet in which an error has occurred when the terminal detects failure of MBMS packet reception, and the fourth step in which the base station retransmits an MBMS packet in response to the retransmission request feedback will be described in detail below.

Error Packet Retransmission Request Information Transmitting Step

States of a terminal in a cellular mobile communication system can be classified into an active state or connected state in which a connection for packet data exchange between the terminal and a base station is set, and an idle state in which data can be received or transmitted with no connection after a connection is set through a downlink (DL) paging procedure or a UL random access procedure.

Even if a connection is set between a terminal and a base station, packet-based mobile communication systems allow an operation of monitoring a control signal of the base station by predetermined periods (i.e., discontinuous reception (DRX) periods) when there is no data to transmit or receive for a predetermined time or according to a control of the base station or a request of the terminal, like in the idle state. During a DRX operation in such a connected state, UL physical (PHY) layer synchronization may not be maintained, like in the idle state. Thus, to transmit a signal including feedback information on a UL, a synchronization process such as a random access procedure should be performed in advance for synchronization. Also, when the base station informs the terminal that there is packet information to be transmitted to the terminal, the base station should inform the terminal that there is DL reception information using control information, etc. in a DL monitoring section, like in the paging process of the idle state.

MBMS packet information should be received regardless of the state of the terminal. Thus, radio resources and a procedure for the third step in which the terminal reports failure of MBMS packet reception may vary according to the state of the terminal.

When the terminal attempts to receive an MBMS packet in a base station transmission period in which the MBMS packet exists and recognizes packet failure, the feedback transmission timing of the terminal which should inform the base station of the packet failure is determined according to a predetermined timing relation.

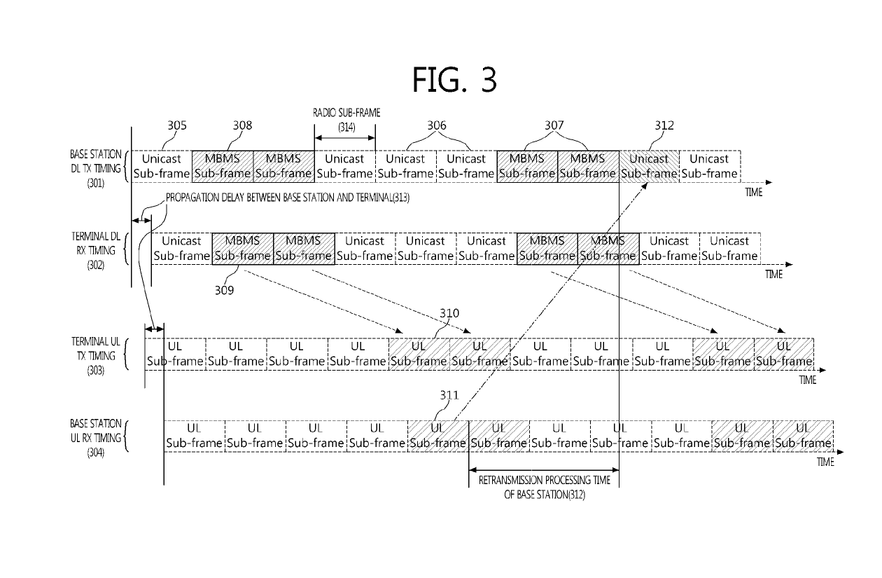

FIG. 3 is a frame timing diagram illustrating transmission and reception timing for an MBMS error packet retransmission request and MBMS packet retransmission corresponding to the retransmission request between a base station and a terminal.

FIG. 3 illustrates transmission and reception timing relations between a base station and a terminal for initial MBMS packet transmission of the base station for MBMS retransmission, feedback transmission of the terminal, and MBMS packet retransmission of the base station.

When a base station transmits a DL according to set transmission timing (base station DL transmission frame timing: 301), a terminal receives the DL after a propagation delay 313 dependent on a distance between the base station and the terminal (terminal DL reception frame timing: 302). Also, when the terminal transmits a UL according to set transmission timing (terminal UL transmission frame timing: 303), the base station receives the UL after the propagation delay 313 dependent on the distance between the base station and the terminal (base station UL reception frame timing: 304).

In a DL channel of the base station or a cell in which a system performs transmission in units of radio subframes 314 and a unicast service and an MBMS are provided together, subframes for unicast (e.g., subframes 306) and subframes for the MBMS (e.g., subframes 307) can coexist in one radio frame consisting of a plurality of radio subframes.

The base station assumes that initial MBMS packet transmission is performed in a subframe 308 for an MBMS. After the propagation delay passes, the terminal receives an MBMS packet 309 in the corresponding MBMS subframe and performs a packet demodulation process. The terminal which cannot receive the normal MBMS packet for some reason transmits retransmission request information in a UL subframe 310 corresponding to a terminal transmission section or a specific UL subframe having a predetermined timing relation with a received DL MBMS packet transmission time.

At this time, the terminal can transmit feedback information according to a current state and the type of UL transmission radio resources as described below. The base station may implicitly recognize that an error MBMS packet which has not been normally received by the terminal is the subframe 308 from transmission timing relations between the base station and the terminal, or may explicitly recognize the same from the feedback information of the terminal.

1) In Case of Terminal in Connected State

Terminals in the connected state can be classified as follows: first, terminals which are allocated radio resources (e.g., physical uplink shared channel (PUSCH)) for packet data to be transmitted on a UL at the feedback transmission timing of the corresponding terminal; second, terminals which are not allocated UL radio resources for transmitting a data packet and only have a set UL control channel (e.g., physical uplink control channel (PUCCH)); third, terminals which are allocated radio resources (PUSCH) for UL packet transmission and also have a set available UL control channel (PUCCH); and fourth, terminals which have neither a control channel nor UL radio resources.

(1) Case in Which Radio Resources (PUSCH) for UL Packet Transmission are Allocated

A) In this case, a terminal or terminals can report that an error has occurred in an MBMS packet (e.g., a packet received in the MBMS subframe 308) received together with UL packet data in the UL subframe 310.

B) Accurate transmission timing information that an MBMS packet which cannot be received by the terminal is a packet transmitted in the subframe 308 may be explicitly included in feedback information and transmitted.

C) Control information indicating failure of MBMS packet reception may be configured differently according to whether the control information is recognized by the PHY layer of a base station or the media access control (MAC) layer, which is a higher layer than the physical layer, and the determination is made by a system. According to the current 3GPP standard regulations, simple retransmission is performed in the PHY layer, and retransmission for a hybrid automatic repeat request (HARQ) operation by incremental redundancy (IR) or chase combining is performed in the MAC and PHY layers. However, these layers in which retransmission is performed may be changed, and thus a layer recognizing the control information indicating failure of MBMS packet reception according to an exemplary embodiment of the present invention may also vary according to whether retransmission from a base station is simple retransmission or retransmission for a HARQ operation.

(2) Case in Which Radio Resources for UL Packet Transmission are not Allocated, and Only Available UL Control Channel (PUCCH) is Set

A) In this case, a terminal or terminals having failed in MBMS packet reception report failure of MBMS packet reception using a UL control channel (PUCCH) of the UL subframe 310.

B) The position of radio resources for feedback transmission in a UL control channel (PUCCH) available in the UL subframe 310 set by the terminal or terminals can be deduced from the corresponding DL subframe 308. For example, the position of radio resources for UL feedback transmission can be set as described below.

In general, occupation or allocation of radio resources for a UL control channel may be set to have a close relation with allocation information of the DL control channel (e.g., physical downlink control channel (PDCCH)) or allocation details of a channel for DL data transmission (e.g., physical downlink shared channel (PDSCH)) in a DL subframe set to have a predetermined difference between base station transmission and related terminal transmission.

In other words, it is possible to set a radio resource field for MBMS feedback in a UL control channel using details about radio resource occupation in a PUCCH obtained from PDSCH or PDCCH allocation information of a general DL subframe of the preceding step according to the following methods:

a) a method of setting a relation between a subframe for a DL MBMS and occupation or allocation of radio resources for MBMS feedback in a PUCCH of a UL subframe;

b) a method of setting a radio resource field for MBMS feedback transmission in a PUCCH for feedback transmission using a mapping relation between a UL grant information field transmitted through a DL control channel present in an MBMS subframe and the position of radio resources for a field in a PUCCH; and

c) a method of setting an unused radio resource field in the PUCCH of a UL subframe having a mapping relation with the corresponding PDCCH as a radio resource field for MBMS feedback transmission because unicast PDCCH information on the corresponding DL subframe is not transmitted through the DL control channel of an MBMS subframe.

The mapping relation of radio resources for MBMS feedback information transmission set by at least one of the methods a), b) and c) may be reported in advance to terminals through system information, MBMS configuration information, or so on.

(3) Case in Which Radio Resources (PUSCH) for UL Packet Transmission are Allocated, and Also Available UL Control Channel (PUCCH) is Set

A system or base station may select one of the above-described methods (1) and (2), or a terminal may selectively employ one of the two operation processes. At this time, the base station or system may set one of the methods (1) and (2) for terminals by broadcasting based on MBMS control information or system information (SI) or by radio resource control (RRC) signaling.

(4) Case in which Neither Radio Resources Available for UL Packet Transmission nor UL Control Channel is Set

In this case, a terminal may operate in the same way as in the idle state to be described later. See operation in the idle state to be described later.

Meanwhile, when a terminal reports failure of MBMS packet reception for feedback radio resources of a UL control channel in the above-described procedure, a process such as scrambling or masking may be performed to generate not a terminal-specific feedback signal but a cell-specific feedback signal. In other words, scrambling or masking by which a base station is specified may be performed to indicate a specific base station among receiving base stations. This is intended to specify which base station among a plurality of base stations in an MBSFN area should perform retransmission. At this time, the base station performing retransmission generally becomes a serving cell of the terminal.

2) Feedback Method in Idle State

A terminal in the idle state has no connection for exchanging packet data with a base station. To transmit information on a UL in the idle state, a UL PHY layer should be synchronized first.

Even in the idle state, a terminal can obtain MBMS control information including SI and a multicast channel (MCH) subframe allocation pattern (MSAP) to receive a DL MBMS packet, but should perform a synchronization process according to a random access procedure to report failure of MBMS packet reception on a UL. Thus, after UL synchronization is performed through the random access procedure, retransmission request information can be transmitted using one of the above-described feedback methods (1) to (3) in the connected state.

Meanwhile, a method of reporting failure of MBMS packet reception in the random access procedure may be efficient in comparison with the method of reporting failure of MBMS packet reception after synchronization is achieved through the random access procedure.

To this end, a part of random access (RA) preamble resources for the random access procedure is reserved and allocated, which is reported to all terminals of the base station or in an MBMS area through MBMS control information or SI.

Thus, the resources or index of an RA preamble are/is mapped to one radio frame allocated for a DL by the base station or a plurality of settable MBMS subframes, and thereby reserved and allocated.

When a terminal cannot receive an MBMS packet of a specific MBMS subframe, the terminal transmits a specific RA preamble having a mapping relation with the corresponding frame to a base station. The base station receiving the RA preamble can know in which MBMS subframe the MBMS packet is transmitted and not received by at least one terminal in the service area.

Meanwhile, as mentioned above, terminals corresponding to the case of (4) (i.e., the case in which neither radio resources for available UL packet transmission nor UL control channel is set) in the connected state may also report failure of MBMS packet reception in the same way as a terminal in the idle state.

Retransmission Step

When the terminal reports failure in receiving the MBMS packet of the DL subframe 308 using the UL subframe 310, the base station detects feedback information reporting the failure of MBMS packet reception from radio resources (PUSCH) for UL packet transmission or UL control channel (PUCCH) in a corresponding UL reception subframe 311 or a received specific RA preamble according to the UL reception timing 304.

When feedback information reporting failure of MBMS packet reception is detected from at least one of terminals within the service area of the base station, the base station retransmits the MBMS packet to the at least one terminal having failed in MBMS packet reception using a subframe 312 for unicast after a required base station retransmission processing time 313

The base station retransmission processing time 313 denoting a processing time between the UL subframe 311, by which the base station recognizes failure of MBMS packet reception, and the DL subframe 312, in which the MBMS packet is retransmitted, may be dependent on performance of the base station or may be a value set by a system in advance in consideration of the performance of the base station.

When the base station retransmission processing time 313 is set in advance, the value may vary according to whether or not a random access procedure is required, or may not vary. Also, different values may be applied to base stations or MBMS areas, respectively.

For the fourth step of retransmitting an MBMS packet, radio resource allocation and related control parameter setting may be performed as described below.

As illustrated in FIG. 3, an MBMS packet is retransmitted in the unicast subframe 312.

To this end, when a DL control channel (PDCCH) is transmitted, a part of a scheduling identifier, for example, a cell-radio network temporary identifier (C-RNTI) indicating which terminal or group a control channel element (CCE) belongs to is reserved and allocated as an identifier for transmitting an MBMS-related packet including MBMS control information or retransmitting the MBMS packet, and the MBMS packet may be retransmitted in the unicast subframe 312 using the reserved and allocated C-RNTI for MBMS transmission (referred to as MBMS-RNTI below).

Thus, a terminal or terminals having failed in MBMS packet reception monitor(s) a DL control channel to check whether or not an MBMS-RNTI exists, and access(es) radio resources for DL data transmission addressed by the corresponding DL control channel information to receive the MBMS packet retransmitted by the base station.

At this time, it is possible to determine which MBMS subframe includes an MBMS packet corresponding to the retransmitted MBMS packet according to the following methods:

1) a method of transmitting related control information including MBMS subframe information on the retransmitted MBMS packet using DL control channel information transmitted as an MBMS-RNTI.

2) a method of setting a plurality of MBMS-RNTIs and mapping relations between the MBMS-RNTIs and MBMS subframes present in one radio frame or a plurality of settable radio frames to distinguish the corresponding MBMS subframe on the basis of the mapping relations. Here, the mapping relations may be reported to terminals through SI or MBMS control information.

3) a method of setting in advance a relation between a transmission timing of the MBMS subframe 308 and a transmission timing of the DL subframe 312, in which the MBMS packet is retransmitted, to control the base station to retransmit the MBMS packet and the terminal to receive the MBMS packet at the corresponding timing without additional signaling. In other words, the timing relation is set on the assumption that the timing relation begins not at the UL subframe 311 but at the DL subframe 308 in FIG. 3, unlike the retransmission processing time 313. The timing relation may be reported to terminals through SI or MBMS control information.

4) a method of setting in advance a relation between a transmission timing of the UL subframe 311, in which MBMS feedback information indicating failure of MBMS packet reception is transmitted, and a transmission timing of the DL subframe 312, in which the MBMS packet is retransmitted, to control the base station to retransmit the MBMS packet and the terminal to receive the MBMS packet at the corresponding timing without additional signaling. The timing relation may be the same as the base station retransmission processing time 313 of FIG. 3, and reported to terminals through SI or MBMS control information.

Meanwhile, the MBMS packet can be retransmitted according to a method determined in advance by the base station or a system without feedback information from a terminal indicating failure of MBMS packet reception. For example, for a terminal located in an inter-cell boundary area, a terminal receiving an MBMS not in an MBSFN mode but by single-cell transmission, a terminal located at the boundary of an MBSFN area, and a terminal located in a poor wireless environment area, retransmission may be performed without feedback information on the basis of a predetermined condition.

Here, using the above-described methods 1), 2), 3), etc., base stations may be managed by an MBMS server or a control apparatus or may decide to retransmit the MBMS packet without feedback information from the terminal in units of all base stations in an MBSFN area, a plurality of base stations in the MBSFN area, or single base stations.

In this case, the MBMS packet may be retransmitted by setting a DL subframe for MBMS retransmission or using an MBMS subframe according to an MBMS subframe transmitting method. Alternatively, the MBMS packet may be retransmitted using a unicast subframe as described in the methods 1), 2) and 3).

MBMS packet retransmission may be performed in units of all base stations in an MBSFN area, some of the base stations in the MBSFN area, or single base stations, and may be controlled by an MBMS control apparatus or server. Alternatively, the MBMS packet may be retransmitted by signaling between base stations or according to setting or determination of a base station.

Meanwhile, the MBMS packet may be retransmitted by a base station according to a HARQ retransmission scheme such as IR or chase combining, or a simple retransmission scheme corresponding to a feedback from the PHY layer.

In other words, the MBMS packet may be retransmitted by a base station according to a method (IR) of a general HARQ scheme based on system bit and parity bit conversion. Also, even a simple retransmission scheme using a feedback from the PHY layer can improve the reception performance of a terminal by soft combining (chase combining) between the MBMS packet that a terminal has failed to receive and a retransmission MBMS packet, or simply by selective combining other than soft combining.

A base station for the above-described MBMS retransmission may be replaced by a base station dedicated to MBMS, a small base station, a home base station, or a relay capable of generating or transferring control information other than a general base station. A control parameter is set on the basis of the above-described method.

The above-described method of transmitting error packet retransmission request information and the above-described method of retransmitting an error packet in response to a retransmission request according to an exemplary embodiment of the present invention will be separately described in detail as operation of a terminal and operation of a base station.

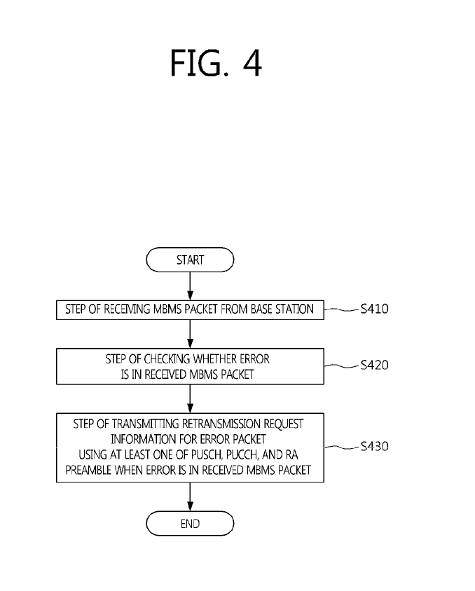

FIG. 4 is a flowchart illustrating a method of transmitting error packet retransmission request information according to an exemplary embodiment of the present invention.

Referring to FIG. 4, in a method of transmitting error packet retransmission request information according to an exemplary embodiment of the present invention, a terminal transmits an error packet retransmission request to a base station in an MBMS when an error occurs in a received MBMS packet. The method may include a step of receiving an MBMS packet from a base station (S410), a step of checking whether an error exists in the received packet (S420), and a step of transmitting error packet retransmission request information using at least one of a PUSCH, a PUCCH, and an RA preamble for a random access procedure (S430).

In step 410, an MBMS packet is received from a base station or base stations through a general MBMS subframe, and in step 420, the received MBMS packet is demodulated and decoded to determine whether an error exists in the received MBMS packet. When an error exists in the received MBMS packet, the whole packet needs to be received again because the error is not corrected by decoding, or an additional parity bit needs to be received to correct the error by a method such as soft combining with MBMS packet data which has been received already.

In the step of transmitting retransmission request information (S430), retransmission request information which requests the base station to retransmit the error packet is transmitted to the base station using at least one of a PUSCH, a PUCCH, and an RA preamble for a random access procedure.

As described above, the retransmission request information may be transmitted through a PUSCH or PUCCH, or may be transmitted after or in a UL synchronization process using an RA preamble.

Here, the retransmission request information may be transmitted through a PUSCH or PUCCH when the terminal is UL-synchronized with the base station and allocated in the active state or the connected state and the terminal and the base station are allocated PUSCH resources or PUCCH resources respectively. Also, the RA preamble may be used when the terminal is in the idle state or is not allocated PUSCH and PUCCH transmission resources.

When the retransmission request information is transmitted through a PUSCH, the retransmission request information may be transmitted to the base station with information indicating an MBMS subframe in which the error packet has been transmitted included in the retransmission request information.

When the retransmission request information is transmitted through a PUCCH, a relation between the MBMS subframe and radio resources in a PUCCH of a UL subframe may be set to implicitly indicate the MBMS subframe in which the error packet has been transmitted. Alternatively, a relation between a UL grant information field of a DL control channel present in a DL MBMS subframe and radio resources in a PUCCH of a UL subframe may be set to indicate the MBMS subframe in which the error packet has been transmitted. Otherwise, the MBMS subframe in which the error packet has been transmitted may be indicated using unused radio resources in a PUCCH of a UL subframe having a mapping relation with a PDCCH of a DL MBMS subframe.

When the retransmission request information is transmitted using an RA preamble, the retransmission request information may be transmitted using an RA preamble reserved and allocated in advance for transmitting retransmission request information between the terminal and the base station among RA preamble resources.

In any case of transmitting retransmission request information using a PUSCH, PUCCH, or RA preamble, at least one of scrambling and masking for specifying a base station to perform retransmission of an error packet may be performed to transmit the retransmission request information.

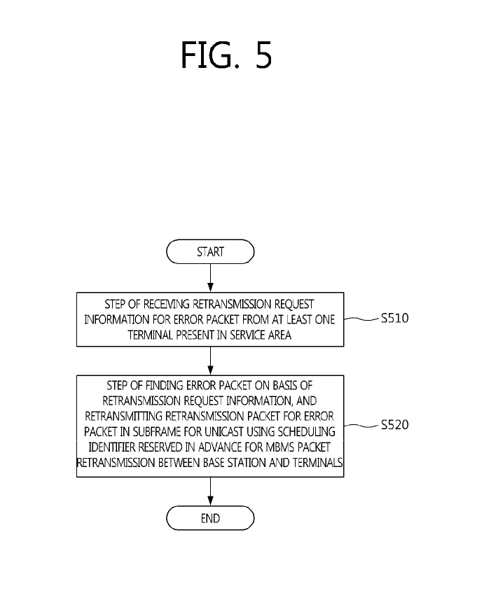

FIG. 5 is a flowchart illustrating a method of retransmitting an error packet in response to a retransmission request according to an exemplary embodiment of the present invention.

In a method of retransmitting an error packet according to an exemplary embodiment of the present invention, a base station retransmits an error packet in an MBMS in response to retransmission request information for the error packet of the MBMS transmitted by a terminal. Here, the error packet retransmission request information may be information transmitted from a terminal according to the method of transmitting retransmission request information according to an exemplary embodiment of the present invention described with reference to FIG. 4.

Referring to FIG. 5, the method of retransmitting an error packet according to an exemplary embodiment of the present invention may include a step of receiving error packet retransmission request information from at least one terminal present in a service area (S510), and a step of finding a packet in which an error has occurred on the basis of the retransmission request information, and retransmitting a retransmission packet for the packet in which an error has occurred in a subframe for unicast using a scheduling identifier reserved in advance for MBMS packet retransmission between the base station and terminals (S520).

In the step of receiving error packet retransmission request information (S510), the error packet retransmission request information may be received from a terminal using at least one of a PUSCH, a PUCCH, and an RA preamble for a random access procedure, like in step 430 described with reference to FIG. 4 in which a terminal transmits retransmission request information.

In the retransmission step (S520), the packet in which an error has occurred is found on the basis of the retransmission request information received from the terminal in step 510, and a retransmission packet for the packet in which an error has occurred is transmitted in a subframe for unicast using a scheduling identifier reserved in advance for MBMS packet retransmission between the base station and terminals.

When the base station transmits a DL control channel (PDCCH), the base station reserves and allocates a part of a scheduling identifier, for example, a C-RNTI indicating which terminal or group a CCE belongs to as an identifier for transmitting an MBMS-related packet including MBMS control information or retransmitting the MBMS packet, and retransmits the MBMS packet in the subframe for unicast using the reserved and allocated MBMS-RNTI, thereby specifying a terminal or terminals to receive the retransmitted packet. Thus, the terminal or terminals having failed in MBMS packet reception monitor a DL control channel to check whether or not an MBMS-RNTI exists, and access(es) radio resources for DL data transmission addressed by the corresponding DL control channel information to receive the MBMS packet retransmitted by the base station.

Meanwhile, the base station should find the packet in which an error has occurred to be retransmitted on the basis of the retransmission request information received from the terminal, and transfer information indicating in which MBMS subframe an MBMS packet corresponding to the retransmission packet is transmitted to the terminal.

To this end, the information specifying the MBMS subframe of the packet in which an error has occurred may be transmitted through a DL control channel(PDCCH) transmitted using a scheduling identifier reserved in advance.

Alternatively, the scheduling identifier may be reserved in advance to be plural in number for MBMS packet retransmission between the base station and terminals, and the packet in which an error has occurred corresponding to the retransmission packet may be transmitted by specifying the MBMS subframe of the packet in which an error has occurred using mapping relations between the scheduling identifiers and MBMS subframes.

Otherwise, a timing relation between a DL MBMS subframe in which the packet in which an error has occurred is transmitted and a unicast subframe in which the retransmission packet is transmitted, or a timing relation between a UL subframe in which the retransmission request information from the terminal is received and the unicast subframe in which the retransmission packet is transmitted may be set in advance to specify the MBMS subframe of the packet in which an error has occurred corresponding to the retransmission packet and transmit the corresponding information.

While the invention has been shown and described with reference to certain exemplary embodiments thereof, it will be understood by those skilled in the art that various changes in form and details may be made therein without departing from the spirit and scope of the invention as defined by the appended claims.

1. A method for a terminal to transmit retransmission request information for an error packet of a multimedia broadcast/multicast service (MBMS) in the MBMS, the method comprising:
receiving an MBMS packet from a base station;
checking whether an error is in the received MBMS packet; and
when an error is in the received MBMS packet, transmitting retransmission request information for the error packet using at least one of a physical uplink shared channel (PUSCH), a physical uplink control channel (PUCCH), and a random access (RA) preamble for a random access procedure.

2. The method of claim 1, wherein when the retransmission request information is transmitted using the PUSCH, the retransmission request information is transmitted with information indicating an MBMS subframe in which the error packet has been transmitted included in the retransmission request information.

3. The method of claim 1, wherein when the retransmission request information is transmitted using the PUCCH, a relation between radio resources in a downlink (DL) MBMS subframe and the PUCCH of an uplink (UL) subframe is set to indicate an MBMS subframe in which the error packet has been transmitted.

4. The method of claim 1, wherein when the retransmission request information is transmitted using the PUCCH, a relation between an uplink (UL) grant information field of a downlink (DL) control channel present in a DL MBMS subframe and radio resources in the PUCCH of a UL subframe is set to indicate an MBMS subframe in which the error packet has been transmitted.

5. The method of claim 1, wherein when the retransmission request information is transmitted using the PUCCH, an MBMS subframe in which the error packet has been transmitted is indicated using unused radio resources in the PUCCH of an uplink (UL) subframe having a mapping relation with a physical downlink control channel (PDCCH) of a downlink (DL) MBMS subframe.

6. The method of claim 1, wherein when the retransmission request information is transmitted using the RA preamble, the retransmission request information is transmitted using an RA preamble reserved and allocated in advance for retransmission request information transmission between the terminal and the base station among RA preamble resources.

7. The method of claim 1, wherein at least one of scrambling and masking for specifying the base station to perform retransmission of the error packet is performed to transmit the retransmission request information.

8. A method for a base station to retransmit an error packet in response to retransmission request information for the error packet of a multimedia broadcast/multicast service (MBMS) transmitted by a terminal in the MBMS, the method comprising:
receiving error packet retransmission request information from at least one terminal present in a service area; and
finding a packet in which an error has occurred on the basis of the retransmission request information, and retransmitting a retransmission packet for the packet in which an error has occurred in a subframe for unicast using a scheduling identifier reserved in advance for MBMS packet retransmission between the base station and terminals.

9. The method of claim 8, wherein retransmitting the retransmission packet includes transmitting the packet in which an error has occurred corresponding to the retransmission packet through a physical downlink control channel (PDCCH) transmitted using the scheduling identifier reserved in advance with information specifying an MBMS subframe of the packet in which an error has occurred included in the packet.

10. The method of claim 8, wherein the scheduling identifier is reserved in advance to be plural in number for MBMS packet retransmission between the base station and the terminals, and
the packet in which an error has occurred corresponding to the retransmission packet is transmitted to specify an MBMS subframe of the packet in which an error has occurred using mapping relations between the scheduling identifiers and MBMS subframes.

11. The method of claim 8, wherein retransmitting the retransmission packet includes transmitting the packet in which an error has occurred corresponding to the retransmission packet to specify an MBMS subframe of the packet in which an error has occurred by setting in advance a timing relation between a downlink (DL) MBMS subframe in which the packet in which an error has occurred is transmitted and a unicast subframe in which the retransmission packet is transmitted or a timing relation between an uplink (UL) MBMS subframe in which the retransmission request information from the terminal is received and the unicast subframe in which the retransmission packet is transmitted.
